(19) United States
(12) Patent Application Publication
(10) Pub. No.: US 2025/0342586 A1
(43) Pub. Date: Nov. 6, 2025

(54) METHOD AND SYSTEM FOR PRECISE, LOCALIZED APPLICATION OF A FLUID OR ELECTROMAGNETIC RADIATION TO TARGETS

(71) Applicant: SprayWize LLC, Cleveland, OH (US)

(72) Inventor: Jorge Zapata, Novelty, OH (US)

(21) Appl. No.: 19/198,862

(22) Filed: May 5, 2025

Related U.S. Application Data
(60) Provisional application No. 63/642,423, filed on May 3, 2024.

(51) Int. Cl. G06T 7/00; G06V 10/26; G06V 20/10

(52) U.S. Cl. CPC G06T 7/0012; G06V 10/26; G06V 20/188; G06T 2207/30004; G06T 2207/30188; G06V 2201/07

(57) ABSTRACT

Disclosed are methods and systems for applying a fluid or electromagnetic radiation to a target.

### CROSS-REFERENCE TO RELATED APPLICATIONS

This application claims the benefit of U.S. Provisional Patent Application No. 63/642,423 which was filed with the United States Patent and Trademark Office on May 3, 2024, the entire contents of which is herein incorporated by reference.

### BACKGROUND

### 1. Field

Example embodiments disclose methods and systems for applying a fluid or electromagnetic radiation to a target.

### 2. Description of the Related Art

Healthy crops are often maintained via use of chemicals such as herbicides, pesticides, fungicides, and fertilizers. Traditional methods of applying such chemicals include the use of sprayers attached to tractors as booms or the use of an airplane in a process known as crop dusting.

### SUMMARY

Traditional methods of applying chemicals to crops to control weeds, pests, and rodents greatly improves crop health, however, such methods generally require a significant amount of fuel to power tractors and/or airplanes. Furthermore, traditional methods of applying chemicals comes with the risk that too little or too much of the chemicals are applied to the terrain and might negatively impact the crops. If too little the chemicals may be ineffective at controlling weeds. If too much then both money and chemicals are wasted, and undesired environmental damage might be generated. Additionally, there are times where the terrain makes it difficult for traditional methods to apply chemicals to crops. For example, it can be quite difficult, or impossible, to drive a tractor over steep slopes or uneven terrain. In view of this, the inventors sought to develop methods of applying chemicals to crops to improve crop health while lowering fuel consumption and conserving chemicals. While the improved methods of applying chemicals to crops is certainly covered by at least one inventive concept disclosed herein, the inventions are not limited thereto. In fact, the inventive concepts disclosed herein are not limited to merely applying chemicals to crops but cover methods of locally applying a fluid (for example, a liquid, a gas, solid particles, or plasma) to a target object, which in one nonlimiting example embodiment, may be a weed and, in another nonlimiting example embodiment, may be an insect and/or animal. In another embodiment, rather than applying a fluid to a target the inventive concepts cover applying a electromagnetic radiation to the target. In yet another nonlimiting example embodiment, the inventive concepts cover a novel method of applying nutrients to the soil.

In one nonlimiting example embodiment the methods utilize a new modular system which may be scalable. For example, in one nonlimiting example embodiment, the method may employ a system having an identification module and at least one application subsystem integrated as one module. This module may be used alone for small applications or with other modules for larger applications. In another embodiment, the single module may have multiple tanks for different types of fluids and/or with multiple radiation sources for multiple radiation type applications.

In at least one nonlimiting example embodiment, the modules may be portable or otherwise movable so that it can be used on different terrains that might be suitable and desirable for the manual, or autonomous application of fluid or radiation by a technician or user, or a vehicle. In one instance, the module can be used as a backpack for application by a technician or end user; in another instance, as a payload for a drone or robotic arm, also as an attachment for an ATV or small vehicle, or as an attachment to a tractor, or as an attachment to a tractor's front or rear boom, etc.

In at least one nonlimiting example embodiment, this new module and method may be used in agriculture processes such as applying pesticides, herbicides, fertilizers, or any other material used for agricultural activities, optimizing resource utilization, and reducing waste. However, the invention is not limited to agriculture since the inventive concepts may be applied across various industries and for various purposes.

In at least one nonlimiting example embodiment, the modules maybe configured to cover large terrains efficiently, providing a more efficient alternative to traditional manual or mechanized spraying methods. The modules may also reduce the application material and the time of application while making such an application targeted and efficient. Further, the disclosed modules may reduce the overall amount of chemicals used. This new method using the modules may also help minimize or reduce the environmental impact of agricultural activities. Further yet, the disclosed modules may be used in areas that may be challenging for traditional machinery, such as steep slopes or uneven terrain. Further yet, the disclosed modules may be configured to collect data on immediate environment-target relationships, such as crop health, allowing users to make informed decisions about their terrain.

Example embodiments disclose a new, novel, modular, scalable method and device to dynamically identify an application target and a new, modular, scalable system to apply a fluid (liquid, gas, solid particles, or plasma) or electromagnetic radiation to a target region.

In example embodiments, the modules may include an identification device that processes data from electromagnetic sensors at the edge (e.g., local computing as in edge computing), at the cloud, or otherwise at a local or remote location to isolate the target from its immediate surroundings based on the target shape (for example, the shape of a leaf or the outline of an insect), the immediate environment-target relationships, the target electromagnetic signature, and otherwise the target identifiable characteristics.

In example embodiments, the modules may utilize a localization system that uses the data from the identification device to determine the application region or plurality of incidence regions. Novel algorithms may then characterize such regions to determine the length of time, intensity, and otherwise necessary characteristics of the application of the fluid or radiation to achieve pre-set and customizable application objectives.

The application device uses the identification device and localization system combined information to actuate mechanisms to apply the fluid or radiation at the target regions. Without intending to limit the invention, the actuators may be embodied as part of a Stewart platform that has the application device(s) mounted on it. In one instance, the camera's field of view may be divided into segments or sectors, which, based on target identification, could be registered to change the position of the Stewart platform for the application device to hit the segment or sector of the field of view.

In example embodiments, the modules and methods that utilize the modules may: automate the target object or region recognition; automate the understanding of the relationship between the target object or region and its immediate surroundings; automate the target object or region recognition by comparing the target object's contour, shape, and/or other characteristics to its surrounding environment; use novel algorithms to define a contour line of a desired target object or region; calculate the segmented field of view of a camera or similar electromagnetic sensor in target objects or regions contour lines for processing; use novel algorithms to define a contour line of a delta from a desired target object or region; calculate a segmented field of view of a camera or similar electromagnetic sensor in delta from target objects or regions contour lines for processing; use the resulting data processing for applying fluids or electromagnetic radiation; use (in at least one example embodiment), reduce the overall amount of chemicals used; minimize or reduce the environmental impact of agricultural activities.

In example embodiments, this new method and system could collect data on immediate environment-target relationships, such as target region characteristics, or, for example, the crop health as a target or non-target, allowing users to make informed decisions about their terrain.

In example embodiments, the exemplary embodiments may reduce the application material and the time of application while making such an application targeted and efficient.

Exemplary embodiments may also overcome problems associated with the conventional art. For example, traditional methods for fluids applications lack the ability to identify a target object or region autonomously for the application and often settles to the application of larger areas or regions.

In some cases, modern methods and devices, targets object or region using image matching segmentation, but might be dependent of traditional imagery for target object selection/comparison, and thus might be limited by the training data. The detection method of example embodiments is superior to traditional methods of detecting/identifying regions and targets.

In the conventional art some traditional or modern methods and devices requires large scale setup and operation. However, because the example embodiments utilize a modular system, large scale setup can be avoided.

The new combined system and method of example embodiments is portable or otherwise movable so that it can be used on different terrains and terrain sizes that might be suitable and desirable for a manual, semi-automatic, or autonomous application of fluid or radiation by a technician or user.

In at least one example embodiment, the exemplary systems and methods may be used in agriculture processes such as applying pesticides, herbicides, fertilizers, or any other material used for agricultural activities, optimizing resource use, and reducing waste.

In example embodiments, this new scalable method and system may cover large terrains efficiently, providing a more efficient alternative to traditional manual or mechanized spraying methods.

In at least one nonlimiting example embodiment, this exemplary new scalable method and system could cover a defined terrain in a precise, “point-to-point” application manner (rather than a blanket application), providing a more efficient alternative to traditional manual or mechanized spraying methods.

In addition, use of the exemplary modules may avoid problems of conventional crop dusting which can include: having adverse effects on the environment; potentially contamination of soil, water, and air; might harm non-target organisms and ecosystems; pose health risks to humans, especially those living close to treated fields; cause respiratory problems, skin irritation, or other health issues from inhalation. Traditional crop dusting is highly dependent on weather conditions. Unfavorable weather, such as strong winds or rain, can limit the effectiveness of the application and may lead to rescheduling or reduced efficiency. Additionally, wind conditions during traditional application can: cause the sprayed substances to drift away from the intended target area; and result in unintentional exposure to neighboring crops, water bodies, or residential areas.

### BRIEF DESCRIPTION OF THE DRAWINGS

Example embodiments are described in detail below with reference to the attached drawing figures, wherein:

FIG. 1 is a scalable application array block diagram;

FIG. 2 is an example of a simplified automated process;

FIG. 3 is an example of a dual application module top view;

FIG. 4 is an example of a dual application module top view

FIG. 5 is a graphical depiction of Segmentation/Application process; and

FIG. 6 is a scalability block diagram.

### DETAILED DESCRIPTION

Example embodiments will now be described more fully with reference to the accompanying drawings. Example embodiments are not intended to limit the invention since the invention may be embodied in different forms. Rather, example embodiments are provided so that this disclosure will be thorough and complete, and will fully convey the scope of the invention to those skilled in the art. In the drawings, the sizes of components may be exaggerated for clarity.

In this application, when an element is referred to as being “on,” “attached to,” “connected to,” or “coupled to” another element, the element may be directly on, directly attached to, directly connected to, or directly coupled to the other element or may be on, attached to, connected to, or coupled to any intervening elements that may be present. However, when an element is referred to as being “directly on,” “directly attached to,” “directly connected to,” or “directly coupled to” another element or layer, there are no intervening elements present. In this application, the term “and/or” includes any and all combinations of one or more of the associated listed items.

In this application, the terms first, second, etc. are used to describe various elements and components. However, these terms are only used to distinguish one element and/or component from another element and/or component. Thus, a first element or component, as discussed below, could be termed a second element or component.

In this application, terms, such as “beneath,” “below,” “lower,” “above,” “upper,” are used to spatially describe one element or feature's relationship to another element or feature as illustrated in the figures. However, in this application, it is understood that the spatially relative terms are intended to encompass different orientations of the structure. For example, if the structure in the figures is turned over, elements described as “below” or “beneath” other elements would then be oriented “above” the other elements or features. Thus, the term “below” is meant to encompass both an orientation of above and below. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

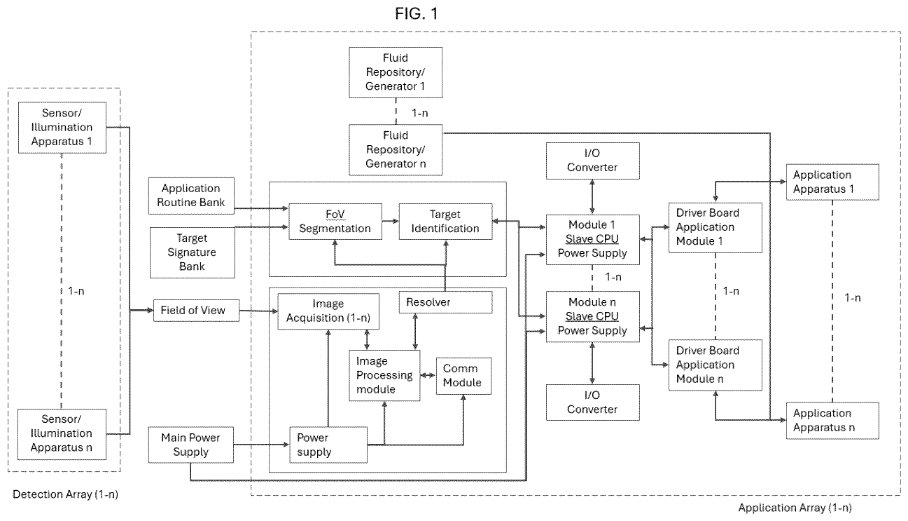

FIG. 1 is a block diagram of an exemplary system showing a scalable application according to this disclosure's inventive concepts. As shown in FIG. 1 the exemplary system may include a Detection Array, an Application Array, and a Main Power Supply to provide power to various elements of the system. The Detection Array may be comprised of a plurality of Sensor/Illumination Apparatuses for sensing an area that includes various targets to be treated and/or objects to be protected. The Sensor/Illumination Apparatuses not only senses and provides image data of targets (and/or objects to be protected) but illumination data (for example, spectral responses) as well. Thus, the Detection Array is capable of generating a Field of View (FoV) that includes not only image data (for example, an outline or shape of a target or object to be protected) but spectral data as well which is usable by the system to identify the targets and/or objects. Examples of Sensor/Illumination Apparatuses include Structured light cameras arrays, infrared cameras or sensors, near-infrared cameras or sensors, other visible, or not-visible spectrum cameras or sensors. The Application Array may include a plurality of Application Apparatuses which may be configured to apply fluids and/or radiation to the targets. Examples of the Application Apparatuses include fluid disperser, fluid nozzle, fluid dripper, antenna, light emitter, light array, laser, etc.

As shown in FIG. 1, the Application Array may include additional elements for processing data from the Detection Array and using this data to control the Application Apparatuses. For example, these additional elements may include an Image Acquisition Module for acquiring FoV data from the Detection Array, an Image Processing Module and Resolver to process and resolve the data from the Detection Array, an FoV Segmentation Module for segmenting the FoV, and a Target Identification Module for identifying targets in the FoV. Each Application Apparatus may be driven by a Driver Board Application module which in turn is driven by a slave CPU where the slave CPUs receive data from the Target Identification Module. In example embodiments, the Target Identification Module may, in one embodiment, identify targets to be treated by a fluid and/or radiation, but in another embodiment may be identify objects, for example, plants, to be protected. In yet another embodiment, the Target Identification Module may be configured to identify both targets to be treated by a fluid or radiation and objects to be protected.

In the nonlimiting example of FIG. 1, the system may include databases useful for readying and operating the system. For example, the system of FIG. 1 may include an Application Routine Bank allowing the system to utilize an application for a particular kind of crop or terrain. For example, a user may inform the system (for example, via a computer interface) that the system will be used to treat a corn field and the system will draw on the Application Routine Bank to extract an application tailored for corn crops. If, on the other hand, the user informs the system the field is wheat, the system will draw on the Application Routine Bank to extract an application tailored for wheat crops. As one skilled in the art would readily appreciate, such routines may help optimize the system. On a similar note, the system of FIG. 1 may include a Target Signature Bank which may include signature data related to targets that need to be identified and treated via application of a fluid and/or radiation. For example, the Target Signature Bank may include signature data such as spectral data related to weeds, rodents, and/or insects. It may also include signature data such as data related to the shape and size of a weed, rodent, or insect. The Target Signature Bank, in another embodiment, may include signature data, such as spectral data, size, data, and shape data related to objects to be protected. In yet another embodiment, the Target Signature Bank may include signatures data for objects to be protected and targets to be treated by a fluid and/or radiation.

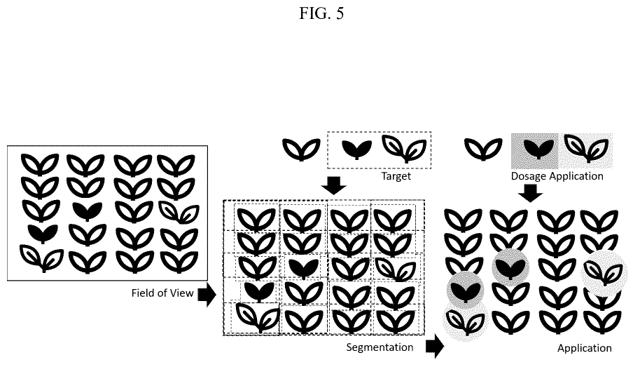

For purpose of clarity FIG. 5 illustrates an example of a FoV comprised of three types of plants. The FoV, in this example, may be generated from data transmitted to the Image Acquisition module from the Detection Array. The FoV may be segmented into various segments associated with the plants. The targets may be identified based on their structural and spectral properties and treated via a dosage application of fluid and/or radiation.

In operation, the Sensor/Illumination Apparatuses of the Detection Array may illuminate and sense various areas. For example, the Sensor/Illumination Apparatuses may sense a structure of a target or an object to be protected (for example, an outline of a target and/or object to be protected, an outline of a leaf of the target and/or object to be protected when the target and or object to be protected is a plant, a target's and/or object's to be protected stem when the target and/or object to be protected is a plant, a target's and/or object's to be protected body structure when the target and/or object to be protected is a plant or animal) and/or detect its spectral characteristics. This FoV data may be provided to the Image Acquisition Module which passes this information to an Image Processing Module which, in conjunction with a Resolver, processes and resolves the FoV. The Resolver may then pass the image to a FoV Segmentation Module and a Target Identification Module to segment the image and identify the targets and/or objects to be protected in the image. Target identification may be based on the structural and spectral characteristics of the target and/or object to be protected. Targets that are identified as needing treatment, for example, by application of a fluid and/or radiation are treated by the Application Apparatuses. For example, the Target Identification Module may communicate with various Slave Module CPUs which control the Application Apparatuses via Driver Board Application Modules to apply a fluid and/or radiation to a target.

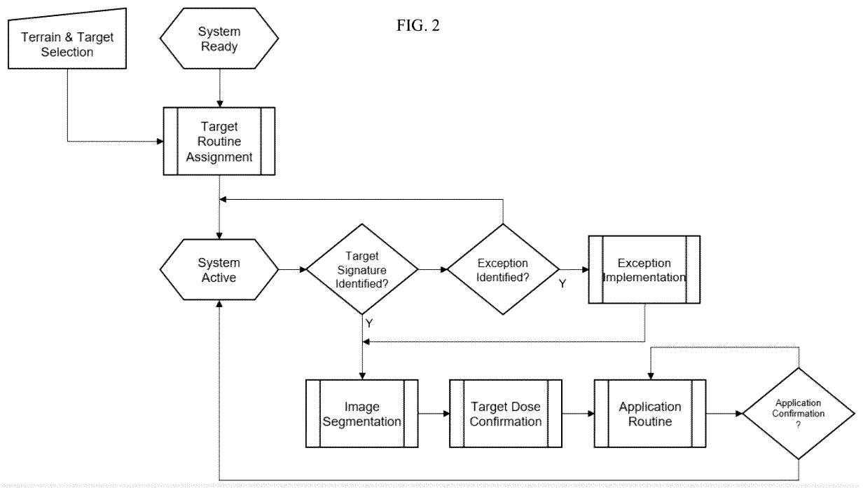

Referring to FIGS. 1 and 2, a process that uses the exemplary system of FIG. 1 may begin with the operation of selecting of Terrain & Target. These operations may be performed by an operator who utilizes the Application Routine Bank and the Target Signature Bank illustrated in FIG. 1. As described above, the Application Routine Bank and the Target Signature Bank may be databases stored in computer memory, for example, on a ROM chip, hard drive, or downloaded in real-time from a remote location. The Application Routine Bank may store algorithms and/or data for different applications. For example, one application may be for corn and another for wheat. The Target Signature Bank may include signature data related to targets and/or objects to be protected. For example, it may contain data related to structural and/or spectral characteristics of the target, for example, a weed or insect and may also contain structural and/or spectral characteristics of an object to be protected, for example, a plant, such as corn or wheat, or an insect, which may be protected by the system. When a user selects the Terrain & Target the system extracts and assigns a Target Routine and the system becomes Active. By way of example only, in this nonlimiting example embodiment, the system of FIG. 1 may be told what kind of crops (terrain) the system will be utilized and informed of the targets to identify (for example, weeds). In another embodiment, the system of FIG. 1 may be told what kind of crops (terrain) the system will protect and the system will apply a fluid and/or radiation to anything which is not a crop to be protected.

As shown in FIG. 2, when the system of FIG. 1 goes into the active state, the system of FIG. 1 actively consumes FoVs, acquires image and spectral data, applies FoV segmentation, and identifies targets. For example, once target signatures are identified the system segments the images, confirms a target, and controls application of a fluid or radiation via an application routine. Once it is confirmed the application has been made the system returns to the active state. In the event a target signature is not identified but an exception is identified (an exception being a unidentified target), the system may calculate the probability the exception is a target that needs to be treated. For example, in the event the exception is a weed or a plant that has not been positively identified, but is identified with enough certainty that the exception requires treatment, for example, by applying a fluid and/or radiation, then the exception will be treated. If not, then the exception is not treated. In another embodiment, when the system of FIG. 1 goes into the active state, the system of FIG. 1 actively consumes FoVs, acquires image and spectral data, applies FoV segmentation, and identifies targets and/or objects to be protected. For example, once FoV is segmented and the objects to be protected are identified, any target (whether identified or not) is treated by an application of a fluid or radiation via an application routine. Once it is confirmed the application has been made the system returns to the active state.

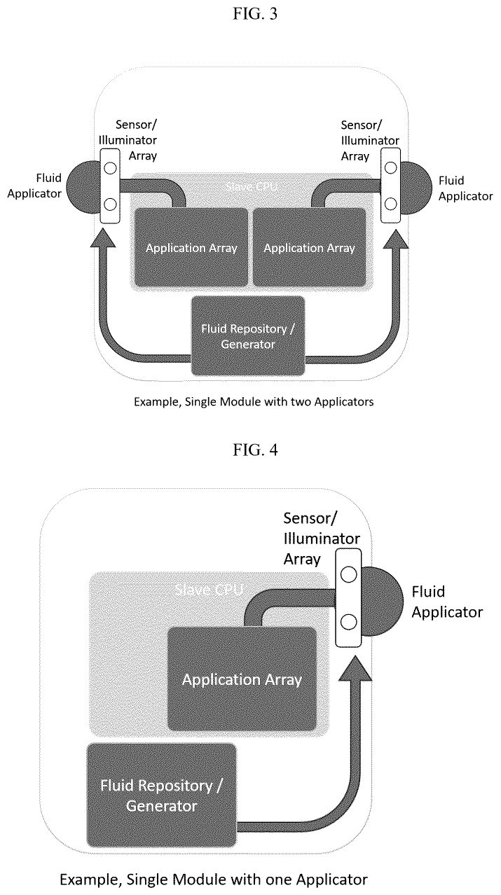

FIGS. 3 and 4 represent two embodiments of a module. FIG. 3, for example, illustrates a first embodiment where the single module includes two applicators which may dispense either a fluid or radiation. Each applicator has an associated Sensor/Illuminator Array (that is, Detection Array) with a fluid Repository/Generator configured to provide fluid to both applicators. FIG. 4 is similar, but shows a module having a single Application Array, a single Sensor/Illuminator Array, with a Fluid Repository Generator. The invention, however, is not meant to be limited by the instant embodiments as the inventive concepts cover modules with more than two Detection Arrays and Application Arrays.

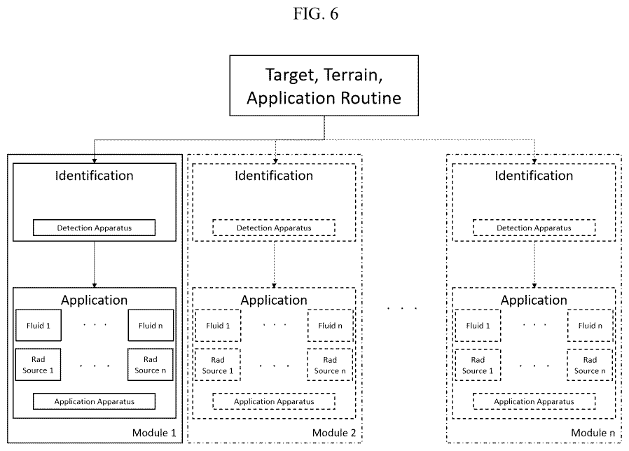

FIG. 6 illustrates another example of the inventive concepts. More specifically, FIG. 6 illustrates a Target, Terrain, Application Routine where multiple Modules are used to detect targets, identify targets, and apply fluids to targets. In the nonlimiting example embodiment of FIG. 6, the modules may be suspended from a boom of a sprayer.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

1. A system comprising:
a detection array configured to generate a field of view including image and spectral data of at least one target; and
an application array configured to receive the field of view data, segment the field of view data, identify the at least one target in the field of view using the image and spectral data, and apply at least one of a fluid and electromagnetic radiation to the at least one target.

2. The system of claim 1, wherein the system includes a target signature bank comprising structural and spectral data of a plurality of targets.

3. The system of claim 1, wherein the system includes an application routine bank comprising a plurality of routines for a plurality of different terrains.

4. The system of claim 1, wherein detection array includes n sensor/illumination apparatus and the application array includes n application apparatuses.

5. The system of claim 1, wherein the application array includes an image acquisition module, an image processing module, and a resolver configured to provide process and provide image and spectral data to a FoV Segmentation Module and a Target Identification Module to segment the image and identify the targets and/or objects to be protected in the image.

6. A method comprising:
selecting a terrain and target from a memory storing a plurality of application routines and target signatures;
receiving field of view data from a detection array where the field of view data includes image data and spectral data;
performing image segmentation of the field of view data and identifying at least one target;
calculating at least one target dose; and
applying at least one of electromagnetic radiation and a fluid to the at least one target.

7. The method of claim 6, further comprising:
identifying an exception; and
implementing an exception routine when the exception is identified.

8. The method of claim 6, wherein the spectral data is generated from illumination of the at least one target by sensor/illumination apparatus.

9. The method of claim 6, wherein the detection array includes n number of sensor/illumination apparatus and the electromagnetic radiation and the fluid is applied via an application array having n number application apparatuses.

10. The method of claim 6, wherein the at least one target is identified using both the image and the spectral data.
